(19) United States
(12) Patent Application Publication
(10) Pub. No.: US 2009/0155154 A1
(43) Pub. Date: Jun. 18, 2009

(54) APPARATUS FOR DECOMPOSING SUFLUR-FLUORINE-CONTAINING COMPOUND AND METHOD THEREOF

(75) Inventors: Shao-I Yen, Hsinchu County (TW); Jung-Nan Hsu, Taichung City (TW); Shou-Nan Li, Nantou County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/956,297

(22) Filed: Dec. 13, 2007

(51) Int. Cl. B01D 53/48; B01D 53/68

(52) U.S. Cl. 423/240 S; 422/171

(57) ABSTRACT

The invention provides a method for decomposing sulfur-fluorine-containing compound and apparatus thereof. Sulfur-fluorine-containing compound is decomposed in two steps, comprising contacting the compound with a first catalyst such as a monometallic catalyst and a second catalyst such as a bimetallic catalyst, and at a low reaction temperature to produce resulting compounds capable of water-solubility. Then, the resulting compounds, namely sulfur- or fluorine-containing compounds, are removed by washing.

### BACKGROUND OF THE INVENTION

1. Field of the Invention

The invention relates to a decomposition method for waste gas and decomposition apparatus thereof, and more particularly to a decomposition method for sulfur-fluorine-containing compound and decomposition apparatus thereof.

2. Description of the Related Art

Currently, perfluorochemicals (PFCs) such as CF₄, C₂F₆, C₃F₈, c-C₄F₈, CHF₃, NF₃, and SF₆ are utilized in the photoelectricity or semiconductor manufacturing industries, for example, thin-film process, etching process and implantation process. Specifically, SF6 is utilized to clean up equipments for dry-etching and chemical vapor deposition (CVD).

Techniques approved by Intergovernmental Panel on Climate Change (IPPC), with destruction and removal efficiency (DRE) to waste gas of 90%, comprise fueled combustion, plasma and catalytic.

For fueled combustion, CH₄ and combustion air are required to generate energy for decomposition of S—F bond by combustion and then produce SO₂F₂, SO₂, SO₃, CO, CO₂ and HF. Typically, a wet scrubbing tower is placed at a rear end of fueled combustion equipment to remove caustic gases and particles. Advantages of furled combustion are fuel CH₄ is required, and byproducts, CO and C₂H₄ are produced.

For plasma, the equipment is placed between turbo pumps and dry pumps. PFCs are bombed by electrons to break C—F bond and transform into HF, CO and CO₂ by washing. Plasma technique for PFCs is only utilized in etching process and its market share is relatively small. Possible reason is that various, high risk gases such as HCN or COF₂ are produced after bombing. Even wet scrubbing towers are unable to effectively remove the all derivatives produced after bombing. Moreover, plasma equipment is located close to vacuum equipment resulting in reactor pollution.

Catalytic is generally utilized in treatment of waste air produced by etching process in the photoelectricity manufacturing industry or semiconductor manufacturing industry. For catalytic equipment, a wet scrubbing tower is placed at the front end of the catalyst bed to remove particles or caustic gases and provide sufficient hydrogen atoms for decomposition of PFCs. Another wet scrubbing tower is placed at the rear end of the catalyst bed for washing HF produced after decomposition of PFCs.

A method for decomposing sulfur-fluorine-containing compound and method thereof is described in EP patent No. 1205234, owned by HITACHI. A gas comprising sulfur-fluorine-containing compound, such as C₂F₆, CF₄, CHF₃, SF₆ or NF₃, is led into a reactor and oxygen and water are then led to the reactor to contact with sulfur-fluorine-containing compound for decomposition. The method, however, requires a reaction temperature in the reactor of up to 650° C.

With expansion of the photoelectricity manufacturing industry and semiconductor manufacturing industry, and reduction in PFCs, requirement of catalytic apparatus for treating waste air has increased. Thus, a decomposition method having effective decomposition of PFCs and reductive transfer ratio of pernicious byproducts is required.

### BRIEF SUMMARY OF INVENTION

Accordingly, the invention provides a method for decomposing a gas comprising sulfur-fluorine-containing compound in low temperature which is oxygen-free and has a two steps catalyst process for decomposition. The method comprises: contacting a sulfur-fluorine-containing compound with a first catalyst; decomposing the sulfur-fluorine-containing compound to produce a first decomposition; and contacting the first decomposition with a second catalyst to decompose and produce a second decomposition capable of water-solubility. By using the method, sulfur-fluorine-containing compound can be decomposed into the compound capable of high water-solubility, such as SO₃ and HF, at low temperature of about 500° C. to 800° C., preferably 580° C. Moreover, sulfur-fluorine-containing compound can be decomposed without oxygen. Because of the resulting compounds water-solubility, they can be removed by washing. For the method, destruction and removal efficiency (DRE) to sulfur-fluorine-containing compound is greater than 99.9% and transfer ratio of the compound incapable of water-solubility can be less than 0.1 mol %.

Also, the invention provides an apparatus for decomposing sulfur-fluorine-containing compound. The apparatus comprises: a first reactor having a first inlet for providing a sulfur-fluorine-containing compound for contacting with a first catalyst therein to decompose and produce a first decomposition and a first outlet for leading the first decomposition out of the first reactor; and a second reactor having a second inlet for providing the first decomposition for contacting with a second catalyst therein to decompose and produce a second decomposition and a second outlet for leading the second decomposition out of the second reactor. In the apparatus, the first outlet connects to the second inlet to lead the first decomposition into the second reactor.

Sulfur-fluorine-containing compound can be decomposed into the compound capable of high water-solubility, such as HF or SO₃, at low temperature of 500° C. to 800° C., preferably 580° C., and under an oxygen-free environment, by the apparatus. Because the resulting compound is capable of water-solubility, compounds can be removed by washing. Moreover, transfer ratio of compound incapable of water-solubility can be less than 0.1 mol % and DRE to sulfur-fluorine-containing compound is more than 99.9%.

A detailed description is given in the following embodiments with reference to the accompanying drawings.

### BRIEF DESCRIPTION OF DRAWINGS

The invention can be more completely understood by reading the subsequent detailed description and examples with references made to the accompanying drawings, wherein:

FIG. 1 is a flow chart for preparing a first catalyst;

FIG. 2 is a flow chart for preparing a second catalyst;

FIG. 3 is a schematic view of decomposition apparatus for sulfur-fluorine-containing compound according to the invention; and

FIGS. 4a-4c are IR analysis charts of the residual sulfur-fluorine-containing compound.

### DETAILED DESCRIPTION OF INVENTION

The following description is of the embodiments for carrying out the invention. This description is made for the purpose of illustrating the general principles of the invention and should not be taken in a limiting sense. The scope of the invention is best determined by reference to the appended claims.

Preparation of a First Catalyst

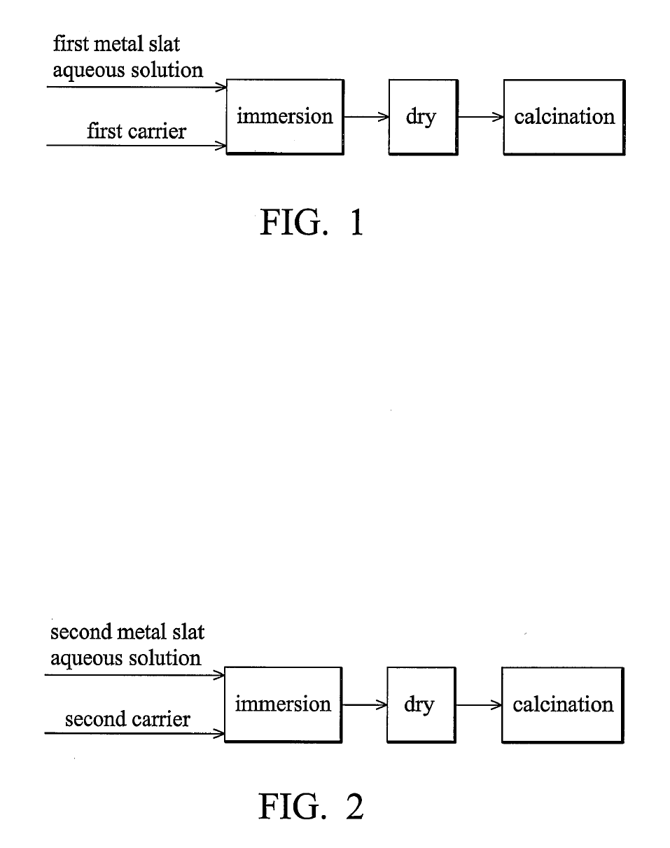

FIG. 1 is a flow chart for preparing a first catalyst. First, γ-aluminum oxide (Al₂O₃) is provided to serve as a first carrier and is not limited thereto. Note that any other materials having relatively large surface area and better absorbability, such as silica gel, magnesium oxide or alumina silica oxide, are also possible for usage.

Then, Al₂O₃ serving as the first carrier was immersed in an immersion solution consisting of a first metal slat aqueous solution. In one embodiment, the slat in the first metal slat aqueous solution may be oxalate, nitride or sulfate, preferably nitride. The metal in the first metal salt aqueous solution may be tungsten (W), nickel (Ni), zinc (Zn) or cerium (Ce), preferably Zn. It is appreciated that the amount of Al₂O₃ relates to that of the metal in the immersion (concentration). In one embodiment where zinc nitride (Zn(NO₃)₂) solution served as the immersion solution, the molar ratio of Zn to the sum of Zn and Al was about 5 mol % to 20 mol %, preferably 10 mol %.

In an exemplary embodiment, 15 g of Al₂O₃ was immersed in 0.1 L of 10 mol % zinc nitride solution at room temperature (25° C.), under low pressure (<1 atm), for 3 hrs to 12 hrs to absorb active component such as Zn on the first carrier such as Al₂O₃. Thus, the first catalyst, such as a monometallic catalyst, was prepared. In the case, the monometallic catalyst was Zn-catalyst. It is understood that the monometallic catalyst may be W-catalyst, Ni-catalyst or Ce-catalyst while the first metal slat aqueous solution comprising W, Ni or Ce, is used.

Referring to FIG. 1, after immersion, the first catalyst was dried at a temperature of about 100° C. to 150° C. for 8 hrs to 12 hrs. Preferably, the first catalyst was dried at a temperature of about 120° C. for 10 hrs to increase its structural strength and uniformly distribute zinc on the aluminum oxide.

Next, the first catalyst was calcined at a temperature of about 650° C. to 800° C. for 4.5 hrs to 5.5 hrs. Preferably, the first catalyst was calcined at about 800° C. for 5 hrs to enhance hardness and obtain appropriate active thereof.

Preparation of a Second Catalyst

FIG. 2 is a flow chart for preparing a second catalyst. γ-aluminum oxide serving as a second carrier is provided and is not limited thereto. Similar with the preparation of the first catalyst, silica gel, magnesium oxide or alumina silica oxide are also possible for usage.

Referring to FIG. 2, Al₂O₃ was immersed in an immersion solution consisting of a second metal slat aqueous solution. The slat in the second metal slat aqueous solution may be oxalate, nitride or sulfate, preferably nitride. The metal in the second metal slat aqueous solution may be manganese (Mn), copper (Cu), zinc (Zn) or cerium (Ce), and preferably copper and cerium. It is appreciated that the amount of Al₂O₃ relates to that of the metal in the immersion solution. In an example of the second metal slat aqueous solution comprising copper nitride and cerium nitride, both the molar ratios of Cu to the sum of Cu, Ce and Al, and Ce to the sum of Cu, Ce and Al were about 3 mol % to 20 mol %, and preferably 3 mol %.

In an exemplary embodiment, 15 g of Al₂O₃ was immersed in 0.1 L of the immersion solution, consisting of 5 mol % copper nitride and 5 mol % cerium nitride, at room temperature (25° C.), under low pressure (<1 atm) for 3 hrs to 12 hrs to absorb active components such as Cu and Ce on the second carrier such as Al₂O₃. Thus, the second catalyst, such as a bimetallic catalyst, was obtained. In the case, the bimetallic catalyst was Cu—Ce-catalyst. It is understood that Cu or Ce in bimetallic catalyst may be replace of Mn or Zn thereof while the second metal slat aqueous solution comprising Mn or Zn, is used.

Referring to FIG. 2, after immersion, the second catalyst was dried at a temperature of about 100° C. to 150° C. for 8 hrs to 12 hrs. Preferably, the second catalyst was dried at a temperature of about 120° C. for about 10 hrs to enhance its structural strength and uniformly distribute copper and cerium on the aluminum oxide.

Next, the second catalyst was calcined at a temperature of about 650° C. to 800° C. for 4.5 hrs to 5.5 hrs. Preferably, the second catalyst was calcined at a temperature about 800° C. for 5 hrs to enhance hardness and obtain appropriate active thereof.

Note that aluminum oxide does not only serve as the carrier for the first catalyst and the second catalyst, but also a catalyst itself to increase decomposition efficiency of the sulfur-fluorine-containing compound.

Method for Decomposing Sulfur-Fluorine-Containing Compound

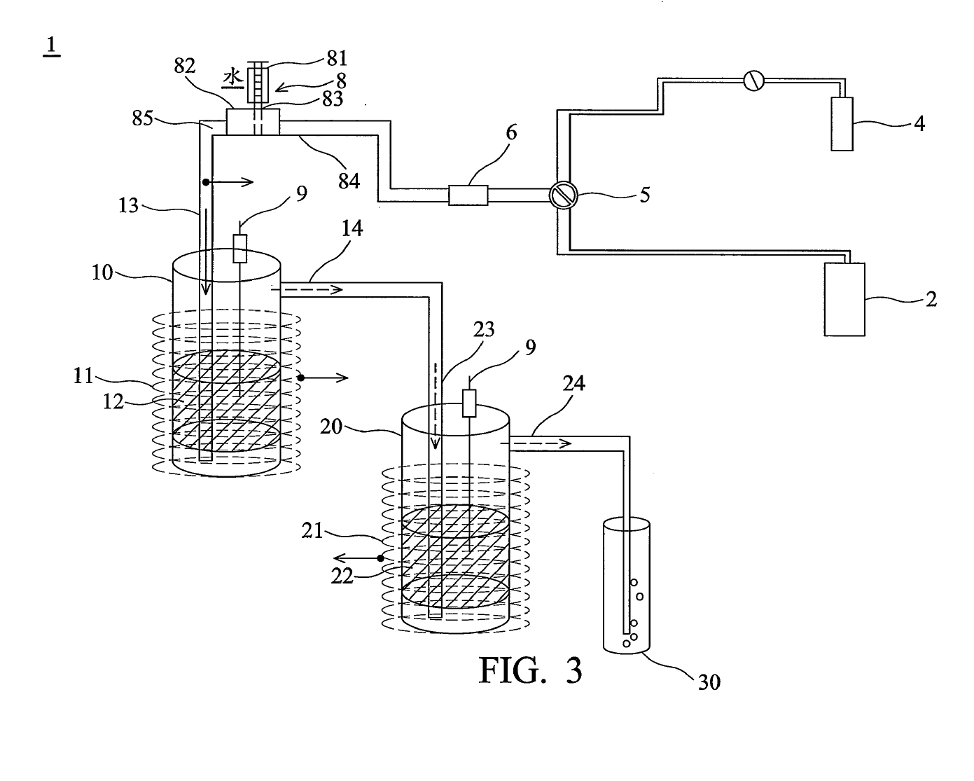

FIG. 3 is a schematic view of an apparatus 1 for decomposing sulfur-fluorine-containing compound. Referring to FIG. 3, a sulfur-fluorine-containing compound supply 2 is utilized to provide a gas comprising sulfur-fluorine-containing compound, such as SF₆, SO₂F₂ or SHOF₂. The invention will be described in a preferred embodiment with SF₆, with concentration of about 200 ppm to 12000 ppm. It is appreciated that SF₆ flow relates to volume of the first catalyst and the second catalyst, for example, gas hour space velocity (GHSV), namely a ratio of SF₆ flow to volumes of the first and the second catalysts, is from 100 h⁻¹ to 2200 h⁻¹. Volume of the first catalyst may be the same as that of the second catalyst or different from each other.

Before sulfur-fluorine-containing compound is provided, an inert gas such as nitrogen (N₂) or helium (He) is provided through an inert gas supply 4 to detect gas leakage. Moreover, the inert gas may also be utilized to dilute and maintain concentration of the sulfur-fluorine-containing compound.

After gas leakage has been detected, the inert gas supply 4 is closed and the sulfur-fluorine-containing supply 2 is opened to provide a gas consisting of 10000 ppm SF₆ for the apparatus 1. The SF₆ gas is led to the apparatus 1 via a valve 5 connected to the inert gas supply 4 to the sulfur-fluorine-containing supply 2 to control gas into the apparatus 1.

After passing the valve 5, the SF₆ gas is led to wetting equipment 8 via a third inlet 84 to add moisture into the SF₆ gas. Moreover, before wetting, the SF₆ gas flow is controlled through a flow controller 6.

The wetting equipment 8 comprises an injector 81, a vaporizer 82 and an injective hole 83, in which the injector 81 connects to and leads external water to the vaporizer 82 via the injective hole 83. Water is vaporized through the vaporizer 82 at a temperature of about 150° C. and then is added into the SF₆ gas with vapor. Because water is in vapor state, the relatively huge amount of moisture is mixed with the SF₆ gas. Note that the led water flow relates to concentration of the SF₆ gas, for example, volume ratio of vapor to the SF₆ gas is of about 30 to 120.

While SF₆ gas passes through the third inlet 84 into the wetting equipment 8, the SF₆ gas is wet and then passes through a third outlet 85 to obtain the SF₆ gas with moisture.

After wetting, the SF₆ gas is then led to a first reactor 10 where a first catalyst 12 is disposed to contact with the SF₆ gas via a first inlet 13, decompose the SF₆ gas and produce a first decomposition such as SO₂F₂, HF and SO₃. Moreover, a heater 11 such as heating coil surrounds the first reactor 10 for heating and a thermocouple 9 is utilized to detect and control temperature of the first reactor 10. Preferably, the first catalyst 12 is a monometallic catalyst such as a Zn-catalyst. W-, Ni- or Ce-catalyst, however, may also be possible.

The first reactor 10 is heated by the heater 11 up to a reaction temperature of about 500° C. to 800° C., preferably 580° C., for 10 mins. While the reaction temperature is stable, the SF₆ gas is led from the first inlet 13 to the first reactor 10 to contact with the first catalyst 12 for producing the first decomposition. The first decomposition is then led out of the first reactor 10 via a first outlet 14. Note that the first catalyst 12 is piled up and disposed in the first reactor 10.

The first decomposition is led from the first outlet 14 to a second reactor 20 via a second inlet 23. A second catalyst 22 is disposed in the second reactor 20 and is in contact with the first decomposition to decompose the first decomposition and produce a second decomposition which comprises SO₃ and HF. Moreover, the second reactor 20 comprises a heater 21 such as heating coil surrounding the second reactor 20 for heating and a thermocouple 9 for detecting and controlling reaction temperature of the second reactor 20. Preferably, the second catalyst 22 is a bimetallic catalyst, for example a Cu—Ce-catalyst. Mn or Zn may also be in place of Cu or Ce.

Note that the first decomposition may be directly in contact with the second catalyst 22 in the first reactor 10 to decompose and obtain the second decomposition rather than being led out of the first reactor 10. The second decomposition is then led to a chamber 30 via the first outlet 14 and the resulting compounds, namely sulfur- or fluorine-containing compound decomposed in the second decomposition, are removed by washing. That is, sulfur-fluorine-containing compound may be decomposed in a single reactor such as the first reactor where the first catalyst 12 and the second catalyst 22 are disposed and is separately in contact with sulfur-fluorine-containing compound to produce the second decomposition. Then, the second decomposition comprising SO₃ and HF is removed by washing.

Moreover, before the first decomposition is led from the second outlet 23 to the second reactor 20, the first decomposition is optionally led to a wetting equipment (not shown) to add moisture to the first decomposition. Through the wetting step, the first decomposition is not only wet, but compounds capable of water-solubility such as HF and SO₃ are also removed from the first decomposition. Furthermore, ratio of compound incapable of water-solubility in the first decomposition, such as SO₂F₂, is increased to increase decomposition efficiency of the sulfur-fluorine-containing compound.

The second reactor 20 is heated up by the heater 21 to a reaction temperature of about 500° C. to 800° C., preferably 580° C., for 10 mins. While the reaction temperature is stable, the first decomposition is led to the second reactor 20 via the second inlet 23 to contact with the second catalyst 22, and decompose and produce the second decomposition which is then led out of the second reactor 20 via the second outlet 24. The second catalyst 22 is piled up and disposed in the second reactor 20 with decomposition efficiency to the first decomposition of 99.9%.

The second decomposition is then led to the camber 30, such as a water trough, a froth trough, or a laundering room, via the second outlet 24. Because the resulting compounds in the second decomposition are capable of water-solubility, such as HF and SO₃, they can be removed by washing.

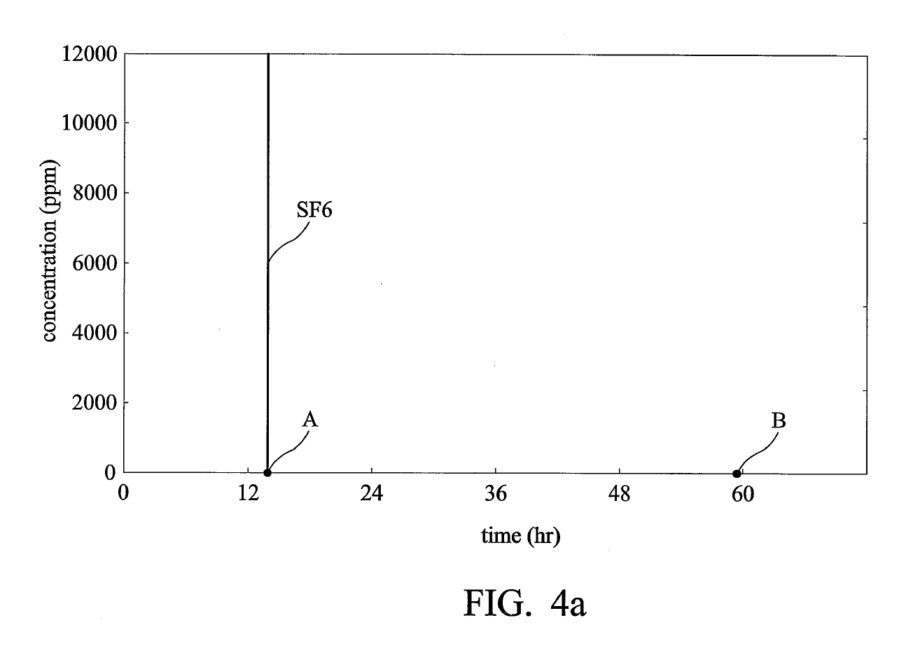

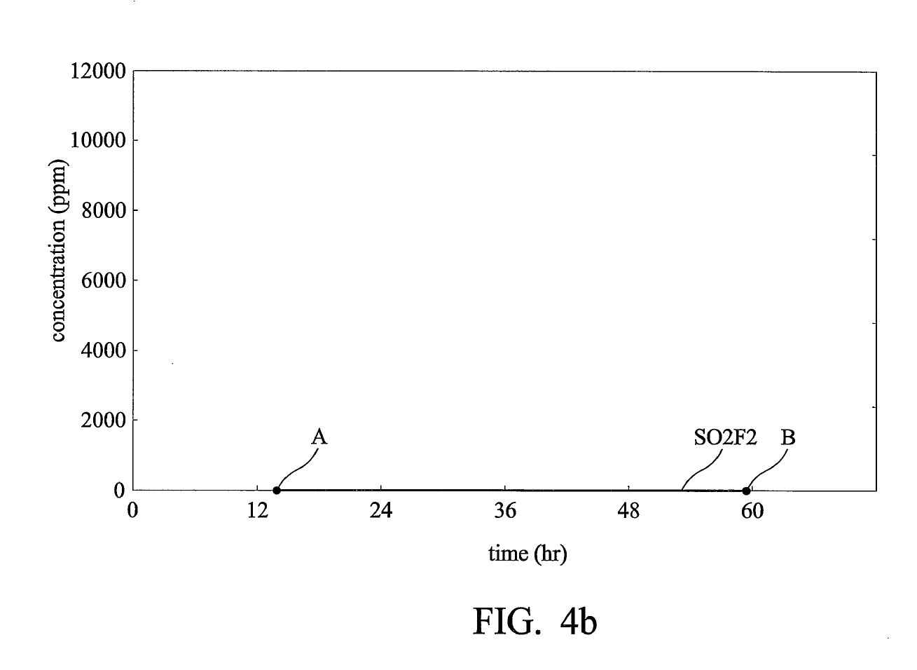

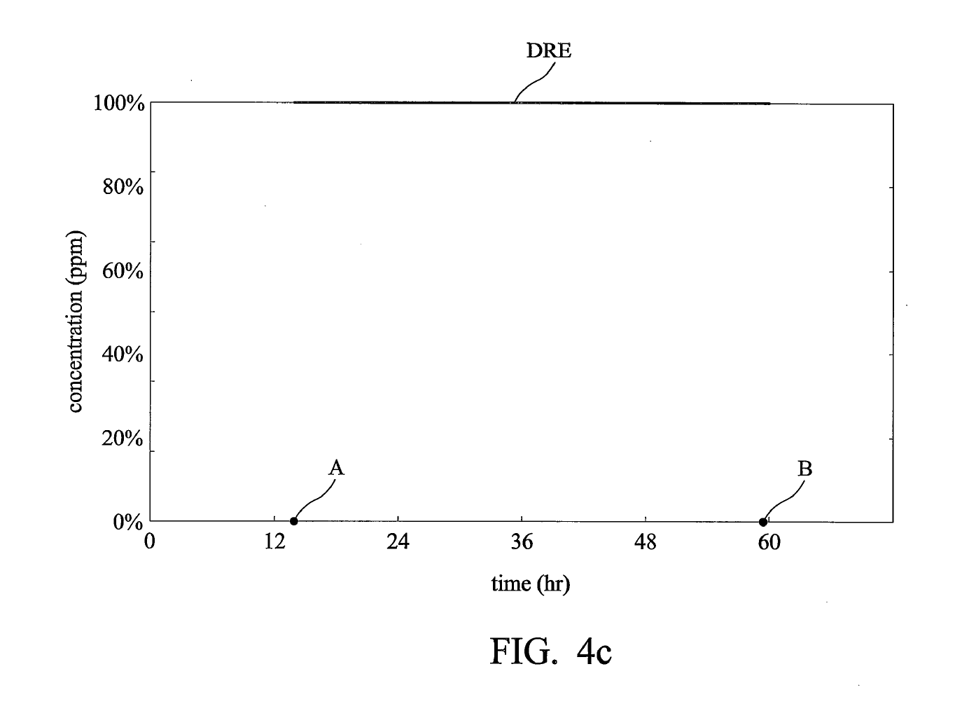

FIGS. 4a and 4b are IR analysis charts of residual SF₆ and SO₂F₂ after treatment of the decomposition apparatus according to the invention, in which abscissa axis is time and ordinate axis is residual concentration of SF₆ and SO₂F₂. In FIG. 4a, point A is initial time for leading the SF₆ gas to the decomposition apparatus and concentration of the SF₆ gas is about 11719 ppm. From FIGS. 4a and 4b, it is found that SF₆ is decomposed at once to produce decomposition comprising SO₂F₂ when the SF₆ gas has been led to the decomposition apparatus (sulfur-fluorine-containing compound is only shown in FIGS. 4a and 4b). SO₂F₂ can't be detected in outlet of the decomposition apparatus after 50 hrs, as shown point B in FIG. 4b, wherein low detection limitation (LDL) of the detector for detecting the residual compounds is 16.9 ppm. That is, sulfur-fluorine-containing compound is almost completely decomposed into compounds capable of water-solubility by the decomposition apparatus. FIG. 4c is a destruction and removal efficiency (DRE) chart of the decomposition apparatus according to the invention. In FIG. 4c, DRE to sulfur-fluorine-containing compound is almost greater than 99.9% when SF₆ has been led to the decomposition apparatus.

### EXAMPLE 1

A gas containing 12161 ppm of SF₆ was provided through the sulfur-fluorine-containing compound supply 2 and ratios of the SF₆ gas flow to volumes of the first catalyst 12 and the second catalyst 22 were about 100 h⁻¹ (gas hour space velocity; GHSV). The SF₆ gas was wet by the wetting equipment 8, in which water was vaporized to be added into the SF₆ gas and ratio of vapor volume to the SF₆ flow was about 30. The wet SF₆ gas was led from the first inlet 13 to the first reactor 10 and was then decomposed into the first decomposition by the first catalyst 12. The first decomposition was led out of the first reactor 10 to the second reactor 20 via the second inlet 23 and was in contact with the second catalyst 22 to decompose and produce the second decomposition comprising the resulting compound such as SO₃, HF and SO₂F₂. Reaction temperatures in the first reactor 10 and the second reactor 20 were both at a temperature of about 680° C. After decomposition, DRE to the SF₆ gas was about 99.9% and transfer ratio of the residual SO₂F₂ to SF₆ was lower than 0.1 mol %. That is, sulfur-fluorine-containing compound was almost completely decomposed into the resulting compounds capable of water-solubility, such as SO₃ or HF. Thus, the second decomposition was removed by water.

### EXAMPLE 2

A gas containing 11719 ppm of SF₆ was provided through the sulfur-fluorine-containing compound supply 2, in which the GHSVs were the same as example 1. The SF₆ gas was wet by the wetting equipment 8 and ratio of the added vapor volume to the SF₆ flow was about 50. The wet SF₆ gas was led from first inlet 13 to the first reactor 10 to decompose and produce the first decomposition. The first decomposition was then led out of the first reactor 10 to the second reactor 20 via the second inlet 23 and was in contact with the second catalyst 22 to decompose and produce the second decomposition. Reaction temperatures of the first reactor 10 and the second reactor 20 were at a temperature of about 580° C. DRE to the SF6 gas in example 2 was about 99.9% and transfer ratio of the residual SO₂F₂ to SF₆ was less than 0.1 mol %. Accordingly, the SF₆ gas was completely decomposed into the resulting compound capable of water-solubility through the decomposition apparatus 1. The resulting compound such as SO₃ and HF in the second decomposition was removed by water.

### EXAMPLE 3

A gas containing 1073 ppm of SF₆ was provided through the sulfur-fluorine-containing compound supply 2, in which the GHSVs were 1216 h⁻¹. The SF₆ gas was then wet and ratio of the added vapor to the SF₆ gas flow was 120. The wet SF₆ gas was led from the first inlet 13 to the first reactor 10 and was decomposed by the first catalyst to produce the first decomposition. Then, the first decomposition was led out of the first reactor 10 to the second reactor 20 via the second inlet 23 and was in contact with the second catalyst 22 to decompose and produce the second decomposition which comprised SO₃, HF and SO₂F₂. Reaction temperatures in the first reactor 10 and the second reactor 20 were at a temperature of about 780° C. DRE to the SF₆ gas was about 99.9% and transfer ratio of the residual SO₂F₂ to SF₆ was less than 1.6 mol %. That is, the SF₆ gas was completely decomposed into compounds capable of water-solubility through the decomposition apparatus according to the invention. Thus, the sulfur- or fluorine-containing compound in the second decomposition was removed by water.

### EXAMPLE 4

A gas containing 1007 ppm of SF₆ was provided through the sulfur-fluorine-containing compound supply 2, in which both GHSVs were 2160 h⁻¹. The SF₆ gas was wet by the wetting equipment 8 in vapor and ratio of the added vapor volume to the SF₆ gas flow was about 75. The wet SF₆ gas was led from the first inlet 13 to the first reactor 10 and was decomposed to produce the first decomposition. The first decomposition was then led out of the first reactor 10 to the second reactor 20 via the second inlet 23 and was in contact with the second catalyst 22 to decompose and produce the second decomposition which comprised SO₃, HF and SO₂F₂. Reaction temperatures in the first reactor 10 and the second reactor 20 were at a temperature of about 780° C. Moreover, DRE to the SF₆ gas in the example 4 was about 97.6% and transfer ratio of the residual SO₂F₂ to the SF₆ gas was less than 3.5 mol %. That is, sulfur-fluorine-containing compound was almost completely decomposed into the resulting compounds capable of water-solubility by using the decomposition apparatus according to the invention. Thus, the resulting compounds in the second decomposition were removed by washing.

### EXAMPLE 5

A gas containing 237 ppm of SF₆ was provided through the sulfur-fluorine-containing compound supply 2, in which the GHSVs were 916 h⁻¹. The SF₆ gas was wet by the wetting equipment 8, ratio of the added vapor volume to the SF₆ gas flow was about 75. The wet SF₆ gas was led to the first reactor 10 via the first inlet 13 and decomposed to produce the first decomposition. The first decomposition was then led out of the first reactor 10 to the second reactor 20 via the second inlet 23 and was in contact with the second catalyst 22 to decompose and produce the second decomposition comprising SO₃, HF and SO₂F₂. DRE to the SF₆ gas was about 99.9% and transfer ratio of the residual SO₂F₂ to SF₆ was less than 7.1 mol %. That is, sulfur-fluorine-containing compound was almost completely decomposed into the resulting compound capable of water-solubility through the decomposition apparatus according to the invention. Accordingly, the resulting compound in the second decomposition was removed by washing.

Although the residual SO₂F₂ existed after decomposition by using the decomposition apparatus according to the invention, the resulting concentration of residual SO₂F₂ was less than low detection limitation (LDL) and transfer ratio, meaning SF₆ transferred into SO₂F₂, were almost less than 0.1 mol %. Thus, the overall SF₆ was almost completely decomposed into the compound capable of water-solubility, such as HF or SO₃. Accordingly, the decomposition apparatus for sulfur-fluorine-containing compound according to the invention had high decomposition efficiency and the resulting decomposition was almost completely dissolved in water, to be removed by washing.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for decomposing sulfur-fluorine-containing compound, comprising:
contacting a sulfur-fluorine-containing compound with a first catalyst comprising a monometallic catalyst;
decomposing the sulfur-fluorine-containing compound to produce a first decomposition; and
contacting the first decomposition with a second catalyst comprising a bimetallic catalyst to decompose and produce a second decomposition capable of water-solubility.

2. The method as claimed in claim 1, wherein the sulfur-fluorine-containing compound comprises SF₆, SO₂F₂ or SOF₂.

3. The method as claimed in claim 1, wherein the first decomposition comprises SO₂F₂, HF, and SO₃.

4. The method as claimed in claim 1, wherein the second decomposition comprises SO₃ and HF.

5. The method as claimed in claim 1, further comprising performing a wetting treatment before contacting the sulfur-fluorine-containing compound with the first catalyst.

6. The method as claimed in claim 1, wherein the first catalyst is prepared by steps comprising:
immersing a first carrier in a first metal slat aqueous solution;
performing a drying step; and
performing a calcining step to prepare the first catalyst.

7. The method as claimed in claim 6, wherein the first carrier comprises aluminum oxide.

8. The method as claimed in claim 6, wherein metal in the first metal slat aqueous solution comprises tungsten, nickel, zinc or cerium.

9. The method as claimed in claim 6, wherein the first metal slat aqueous solution comprises zinc nitrate aqueous solution.

10. The method as claimed in claim 1, wherein the second catalyst is prepared by steps comprising:
immersing a second carrier in a second metal slat aqueous solution;
performing a drying step; and
performing a calcining step to prepare the second catalyst.

11. The method as claimed in claim 10, wherein metal in the second metal salt aqueous solution comprises manganese, copper, zinc or cerium.

12. The method as claimed in claim 10, wherein the second metal slat aqueous solution comprises copper nitrate aqueous solution and cerium nitrate aqueous solution.

13. The method as claimed in claim 1, wherein the sulfur-fluorine-containing compound is decomposed at a temperature of between about 500° C. and 800° C.

14. An apparatus for decomposing sulfur-fluorine-containing compound, comprising:
a first reactor having a first inlet for providing a sulfur-fluorine-containing compound for contacting with a first catalyst therein to decompose and produce a first decomposition and a first outlet for leading the first decomposition out of the first reactor; and
a second reactor having a second inlet for providing the first decomposition for contacting with a second catalyst therein to decompose and produce a second decomposition and a second outlet for leading the second decomposition out of the second reactor;
wherein the first outlet connects to the second inlet to lead the first decomposition into the second reactor.

15. The apparatus as claimed in claim 14, wherein the first inlet connects to a sulfur-fluorine-containing compound supply for providing the sulfur-fluorine-containing compound to the first reactor.

16. The apparatus as claimed in claim 14, further comprising wetting equipment between the first inlet and the supply to wet the sulfur-fluorine-containing compound.

17. The apparatus as claimed in claim 16, wherein the wetting equipment comprises:
an injector for leading water into the wetting equipment; and
a vaporizer having a third inlet, a third outlet and a injection hole connected to the injector to lead the water into the vaporizer for vaporization, the third inlet connected to the sulfur-fluorine-containing compound supply to wet the sulfur-fluorine-containing compound, and the third outlet connected to the first inlet to lead the wetted sulfur-fluorine-containing compound into the first reactor.

18. The apparatus as claimed in claim 14, further comprising an inert gas supply to provide an inert gas for detecting gas leakage or diluting concentration of the sulfur-fluorine-containing compound.

19. The apparatus as claimed in claim 14, wherein the first catalyst is piled up and disposed in the first reactor and the second catalyst is piled up and disposed in the second reactor.

20. The apparatus as claimed in claim 14, wherein the second outlet connects to a chamber where the second decomposition is led and removed by washing.
